(19) United States
(12) Patent Application Publication
(10) Pub. No.: US 2010/0138260 A1
(43) Pub. Date: Jun. 3, 2010

(54) METHOD FOR OPTIMIZING THE OPERATION OF A SYSTEM FOR REALIZING AT LEAST ONE ONLINE POLL AND A SYSTEM FOR PERFORMING THE METHOD

(75) Inventor: Frank SMADJA, HAIFA (IL)

Correspondence Address: YOUNG & THOMPSON, 209 Madison Street, Suite 500, Alexandria, VA, 22314, US

(73) Assignee: TOLUNA, LEVALLOIS-PERRET (FR)

(21) Appl. No.: 12/628,290

(22) Filed: Dec. 1, 2009

(30) Foreign Application Priority Data
Dec. 2, 2008 (FR) 08 06769

(51) Int. Cl. G06Q 10/00

(52) U.S. Cl. 705/7

(57) ABSTRACT

A method for optimizing the operation of a system for distributing at least one poll over the Internet, includes successive steps for:

classifying and/or grouping publishers according to one or more data items relating to a particular website;

classifying each poll according to the distance from each group of publishers; and

determining pairs [poll, site] by applying an algorithm of the k nearest neighbours type (KNN); and

making a classification of each pair [poll, site] according to the click-through rate on the site of the pair, such a classification being known as the popularity rank.

This invention refers in particular to the field of online advertising, more specifically targeted advertising via Internet. This invention can be applied, but is not exclusively intended for, a specific type of advertising that may be used for marketing studies, polls.

This type of advertising shall hereinafter be referred to as a “poll”. The term “poll” is used in its broadest sense, i.e. a means of collecting the opinions of a large number of online users. There may be multiple types of such polls. Such a poll may be a standard poll, in which the users have a choice between several possible answers. It may equally be a type that allows a user to give an opinion or comment etc. on any theme whatsoever. In its general form, the poll may simply be an advertising banner asking the user to click through to a sub-zone. A poll may equally be a combination of questions, banners, free-format fields, etc. Polls are generally placed on websites that generate traffic as a function of their content.

A poll generally waits until it has acquired a specific number of votes. In this context, a poll having received the selected specific number of votes selected is qualified as a completed poll.

The owner of the Internet site, for example a website or a blog, on which the poll is displayed is referred to as the “publisher”; the client who whishes to realise any marketing study is referred to as the “advertiser” and the system for distributing or syndicating the polls on the publishers' sites is referred to as the “poll network”.

For a given website, for example, and a given visitor to that site, one problem that arises is determining which poll or polls should be shown to the visitor of this site, based on the information that is known about the site, the visitor and various possible polls.

Generally an expiry date on which the poll will be closed is provided, whether it has been completed or not. It is desirable that the poll be completed before the expiry date.

The aim of the invention is to be able to classify polls, for example as a function of a score, in order to achieve one or more of its objectives, comprising:

to get a better flow, that is to say to improve the number of polls completed by a visitor;

to encourage every visitor to respond quickly to popular polls, so that he will always be entertained and interested; and

to allow manual access to specific polls by means of a back-office system in order to facilitate publication on the poll network;

to publish polls for a visitor that are relevant to him, depending on data about the visitor, the site or the poll.

It should be noted that our invention does not imply a bidding system at the end of which the poll will be published depending on the price that would be ready to pay. The price paid by the advertiser is not linked to the system presented here.

In the invention, provision is made to detect the polls that have been achieved and to favour the less popular polls that have not yet been completed, particularly when their expiry date is approaching.

The ranking of a poll can be performed as a function of a combination of the following elements:

a popularity score, which could equally take account of known data about the user and the content of the website and the poll;

a manual score; and

an urgency score such as that defined below by formula II:

urgency_score=votes_needed/days_remaining

And the general ranking of a poll can for example be defined by the following algorithm, formula III:

ranking=f1 (urgency_factor, urgency_score, popularity_score)

where f is a function that increases with the urgency factor, the urgency score and the popularity score.

It may also be useful to add a score manually and the formula is then completed as follows:

ranking=f2 (manual_score, urgency_factor, urgency_score, popularity_score)

Function f2 should preferably be defined by the following formula:

ranking=if (manual_score is not null) then manual_score

else

f1 (urgency_factor, urgency_score, popularity_score)

Function f1 should preferably be defined by the following formula:

f1 (urgency_factor, urgency_score, popularity_score)=urgency_factor*urgency_score+popularity_score

In these formulae:

manual_score represents a ranking that has been imposed manually. This ranking could also be modified using scripts. The manual score allows the function's calculation to be overridden, i.e. allows a particular ranking to be imposed manually.

urgency_factor is a coefficient allowing adjustment of the formula depending on a specific application. An urgency factor of the order of 1000 is generally preferred. The purpose of the urgency factor is to allow greater or lesser prioritisation of polls that have a backlog or that are known in advance to be likely to be less popular.

votes_needed represents the numbers of votes missing and required for the poll to be complete.

days_remaining represents the residual duration of the poll, or to put it another way, the number of days remaining to complete the poll.

We are now going to describe a specific method of implementing the invention.

An invention such as this can be used by an advertising network whose clients who are interested in marketing studies will pay on the basis of such polls. Publishers supply the network with space on a website or a blog, and the advertising network places polls on an publisher's site or sites using the ranking algorithm described above.

Under this method of implementation, the ranking algorithm can be used as follows:

using a clustering algorithm to group publishers together according to the content of their sites. This clustering can be performed as a function of the content of the sites or using meta-information provided as beacons, anchor texts and backlinks;

using a distance to the cluster as a way of ranking the polls for each group of publishers;

determining the best polls for each cluster; and

applying an algorithm of the k nearest neighbours type (KNN),

altering the ranking for each pair [poll, site] depending on the click-through rate on the site in question and using this value as a “popularity score” and,

using the algorithm of formula III for altering the ranking of each pair [visitor, poll] according to the urgency of the poll.

It should preferably be possible inter alia to monitor the saturation of a system for handling polls, warn the user about it, and avoid activating a poll that could not be completed.

The overall shortfall in the system is defined as the total number of votes needed to complete the open polls as a whole. This number is represented by the term SHORTFALL. By way of an example:

if 153 polls are open at a given moment and

each poll has to reach a figure of 1000 participants

the shortfall will be less than or equal to 153,000. It will be less than 153,000 as long as one or more visitors have already responded to one or more of the polls.

The daily revenue is the total number of active voters in the polls on a given day. This revenue can be calculated once a day and saved in a semi-permanent means of storage in the system, for example a global cache memory, a database, etc. This number is represented by the term DAILY_REVENUE.

The average daily revenue is an average figure for the daily revenue calculated over a given number of days. This average is represented by the term AVERAGE_DAILY_REVENUE. For example, the average can be calculated for a week, i.e. 7 days. It can also be saved in a semi-permanent means of storage.

The daily expenditure corresponds to the total number of new votes required for the polls created on that day to be completed. So, for instance, if there are 200 new polls on this day and each poll requires 1000 votes to be completed, the corresponding daily expenditure comes to 200,000 units. This number is represented by the term DAILY_EXPENDITURE.

Based on the numbers given previously, it is possible to calculate the shortfall in the system. The system shortfall increases over a given period, for example a week or a month, if the number of units spent exceeds the number of units acquired. So, for a given day, the shortfall increases if the daily expenditure for the day is greater than the daily revenue.

It is then possible to calculate the system saturation, i.e. a value relating to the shortfall and an acceptable period for this shortfall to be made good.

To provide greater flexibility in allowing variations in the shortfall and/or allowing certain shortfall levels, the shortfall can be linked to a period covering several days, instead of just one.

It is beneficial to be able to estimate that the system will reach saturation when the period for making the shortfall good exceeds the average lifespan of a type of poll such as those implemented by the system. In fact, one can say that it will not be possible to complete certain polls above this average lifespan.

The saturation can thus be defined by formula I

saturation=f3 (SHORTFALL, AVERAGE_DAILY_REVENUE, DAYS)

Function f3 should preferably be defined by the following formula:

saturation=SHORTFALL/(AVERAGE_DAILY_REVENUE*DAYS)

Where DAYS is the number of days that the shortfall has been averaged out over.

DAYS should preferably be equal to the average lifespan of a poll in the said system.

According to this formula, the system is considered to be saturated when the saturation value is greater than or equal to 1.

If the number of days for the average life span of a particular type of poll in the system is one week, DAYS should preferably be set to 7. In this example, the system is therefore considered to have reached saturation if more than one week is required to make good the SHORTFALL, taking account of the known average daily revenue.

Once the system has saturated, every new poll can be put on a waiting list until the system is no longer saturated. The waiting list should preferably be validated every day in FIFO sequence (first in, first out).

Each new poll can be activated once the system is no longer saturated.

1. A method for optimising the operation of a system for distributing at least one online poll, consisting of successive steps for:
classifying and or clustering publishers according to one or more data items relating to a particular website;
ranking each poll according to the distance from each group of publishers; and
determining pairs [poll, site] by applying an algorithm of the k nearest neighbours type (KNN); and
performing a ranking of each pair [poll, site] according to the rate at which clicks occur on the site of the said pair, such a ranking being known as the popularity rank.

2. A method according to claim 1, wherein the ranking of each pair can inter alia be modified depending on an urgency score for the pair's poll.

3. A method according to claim 2, wherein the ranking is calculated according to a formula of the following type:
ranking=f1 (urgency_factor, urgency_score, popularity_score)
where f1 is a function that increases with the urgency factor, the urgency score and the popularity score.

4. A method according to claim 3, providing for the possibility of imposing a manual ranking in which said ranking is calculated according to a formula of the following type:
ranking=f2 (manual_score, urgency_factor, urgency_score, popularity_score)
where f2 is a function that increases with the urgency factor, the urgency score and the popularity score.

5. A method according to claim 4, wherein the ranking is calculated according to a formula of the following type:
ranking=if (manual_score is not null) then manual_score selse
f1 (urgency_factor, urgency_score, popularity_score)

6. A method according to claim 4, wherein function f1 is defined by the formula:
f1 (urgency_factor, urgency_score, popularity_score)=urgency_factor*urgency_score+popularity_score

7. A method according to claim 3, wherein the calculations comprise the saturation of the system is further calculated according to a formula of the following type:
saturation=f3 (SHORTFALL, AVERAGE_DAILY_{—REVENUE, DAYS)}

8. A method according to claim 7, wherein:
saturation=SHORTFALL/(AVERAGE_DAILY_REVENUE*DAYS)
where “days” equals the average lifespan of a poll in said system.

9. A method according to the claim 8, wherein every new poll is put on a waiting list, preferably of the FIFO type, once the saturation is greater than or equal to one.

10. A system for implementing a method according to claim 1, comprising:
database means for the websites;
database means for one or more polls;
means for comparing said databases against each other; and
means for carrying out a poll on a site.

11. A system for implementing a means according to claim 10 comprising:
means for calculating a daily revenue of the system;
means for calculating a shortfall of the system;
means for deriving a saturation figure of the system; and
means for putting each new poll on a waiting list when said system is saturated.
